(19) United States
(12) Patent Application Publication
(10) Pub. No.: US 2025/0339811 A1
(43) Pub. Date: Nov. 6, 2025

(54) DRYER DEVICE, EXPANSION TANK AND BATTERY COOLING SYSTEM

(71) Applicant: MAHLE International GmbH, Stuttgart (DE)

(72) Inventors: Markus Lang, Loechgau (DE); Ralf Zink, Stuttgart (DE)

(21) Appl. No.: 18/979,575

(22) Filed: Dec. 12, 2024

(30) Foreign Application Priority Data
Dec. 15, 2023 (DE) 10 2023 135 284.9

(51) Int. Cl. B01D 53/26; B01D 53/04; B01D 53/28; H01M 10/613; H01M 10/6568

(52) U.S. Cl. CPC B01D 53/261; B01D 53/0446; B01D 53/28; H01M 10/613; H01M 10/6568; B01D 2253/102; B01D 2253/108; B01D 2257/702; B01D 2257/80; B01D 2258/06

(57) ABSTRACT

A drying device for an expansion tank in a battery cooling system can be implemented in various configurations. In some configurations, the drying device includes an air-permeable, bag-like housing containing a drying agent. In another configurations, the drying device includes a dimensionally stable drying body formed from a sintered, extruded, or sprayed drying agent.

### CROSS-REFERENCE TO RELATED APPLICATION

This application claims priority to German Patent Application No. DE102023135284.9, filed on Dec. 15, 2023, the contents of which is hereby incorporated by reference in its entirety.

### TECHNICAL FIELD

The present invention relates to a drying device of an expansion tank for a battery cooling system. The invention also relates to an expansion tank with such a drying device and a battery cooling system with such an expansion tank.

### BACKGROUND

Electric or hybrid vehicles are increasingly becoming the focus of consumers due to environmental aspects and are therefore also becoming more widespread on the roads. In order to be able to increase both the range and the performance of such electric or hybrid vehicles, the aim is to keep a traction battery of such an electric or hybrid vehicle in an optimum temperature window for this traction battery, for which temperature control devices, in particular cooling devices, are used in a known manner.

Such a battery cooling system for cooling a traction battery in particular also includes an expansion tank in which air is stored as an expansion cushion for a temperature-related change in volume of the coolant. An increase in temperature causes the coolant to expand, which could lead to a high pressure load in the expansion tank and possibly damage it if the resulting excess pressure cannot escape and should therefore be avoided. For this reason, such expansion tanks usually have a connection to the environment in order to be able to reduce a temperature-related pressure difference by blowing air into the environment if necessary. In order to prevent or at least reduce the unwanted discharge of hydrocarbon compounds into the environment, activated carbon filters were previously provided through which the air to be blown out into the environment flowed and which were arranged separately from the expansion tank. When the coolant cools down, it contracts, creating a vacuum in the expansion tank, which leads to fresh air being drawn in from the environment. In order to prevent or at least reduce the undesirable introduction of moisture into the coolant, so-called dryer cartridges have been provided to date, in which a drying agent was arranged, through which the fresh air drawn in from the environment flowed during the intake process, absorbing moisture and drying the fresh air drawn in.

However, the disadvantage of such drying devices is that they are comparatively expensive to manufacture.

### SUMMARY

The present invention therefore deals with the problem of providing an improved or at least an alternative embodiment for a drying device, by means of which the disadvantages known from the prior art can be overcome.

According to the invention, this problem is solved by the subject matter of the independent claim(s). Advantageous embodiments are the subject matter of the dependent claim(s).

The present invention is based on the general idea of being able to construct a drying device of an expansion tank of a battery cooling system in a completely different way for the first time and thus be able to manufacture and install it extremely cost-effectively. The drying device according to the invention has either an air-permeable, bag-like housing in which a drying agent is arranged, for example loose bulk material, or a dimensionally stable drying body made of a sintered, extruded, or sprayed drying agent. Both the drying device with the bag-like housing and the drying agent arranged therein, and the dimensionally stable drying body are extremely cost-effective embodiments, which can also be positively inserted into associated receptacles in a tank housing of the expansion tank and thus installed. Of course, such a dimensionally stable drying body can also be arranged in the bag-like housing. This also makes it comparatively easy to replace the drying device by removing it from the tank housing and inserting a new drying device into the corresponding receptacle.

In an advantageous further development according to the first alternative of the drying device according to the invention, the bag-like housing is made of polyester fabric. Polyester is lightweight and also does not absorb moisture, so the moisture absorption is caused solely by the drying agent. The design of the bag-like housing made of polyester fabric offers the advantages of high strength, good processability and weldability as well as high air permeability.

The drying agent is conveniently arranged as free-flowing bulk material in the bag-like housing. As a result, the dryer device adapts optimally to an inner contour of the first receptacle in the tank housing of the expansion tank and can be accommodated therein in a form-fitting and fixed position. Manufacturing tolerances, which can lead to an undesirable bypass flow in rigid housings, can also be avoided with this type of design.

In another advantageous embodiment, the drying agent comprises silica gel or zeolite. Silica gel is a colorless silicon dioxide with a gel-like, rubbery to solid consistency. It has a large inner surface area (approx. 600 m²/g) and is highly water-absorbent. Zeolite can absorb up to half of its own weight in moisture and generates heat in the process, which can also aid drying. The use of zeolite offers a strong dehumidification effect even at low moisture levels, while silica gel has a high water absorption rate and is also inexpensive.

The dimensionally stable drying body made of a sintered, extruded, or sprayed drying agent expediently has a shape that is complementary to an inner contour of a first receptacle in a tank housing of an expansion tank, in particular a rod-like shape. In this way, a positive insertion of the drying device into the associated first receptacle of the tank housing can be achieved without the dimensionally stable, extruded, sintered, or pressed drying agent requiring an additional housing, which can reduce manufacturing costs.

The present invention is further based on the general idea of forming an expansion tank for equalizing an air volume due to a temperature-related change in volume of a cooling medium, in particular oil, with a double-shell tank housing with a first receptacle in which the drying device according to the invention can be arranged in a form-fitting manner. The expansion tank according to the invention, in particular for air, for a battery cooling system has the aforementioned tank housing made of plastic with a first shell and a second shell tightly connected thereto. In the first tray and/or in the second tray, the first receptacle is/are formed, in which the drying device according to the invention is positively received with a drying agent, for example zeolite or silica gel, in accordance with one of the preceding paragraphs, while an activated carbon cartridge can be arranged in a second receptacle, which can also be arranged in the first tray and/or in the second tray. Such an activated carbon cartridge is able to absorb pollutants such as hydrocarbons. A first valve is also provided, via which air can be blown out of the expansion tank into the environment when there is excess pressure in the expansion tank, and a second valve, via which fresh air can be sucked into the expansion tank from the environment when there is negative pressure in the expansion tank. The term “fresh air” can/should be understood as ambient air. The double-shell design of the tank housing of the expansion tank with the drying device and activated carbon cartridge arranged therein makes it possible to create an overall very cost-effective tank housing of the expansion tank, while at the same time offering assembly advantages, since the drying device, which is designed as an insert, only needs to be inserted positively into the first receptacle of the first and/or second shell and optionally the activated carbon cartridge, which is designed as an insert, needs to be inserted positively into the second receptacle of the first and/or second shell and then the two shells of the tank housing need to be tightly connected to one another. This also makes it possible to achieve an arrangement of the drying device or activated carbon cartridge in the tank housing that is protected over its service life. This completely eliminates the need to manufacture the tank housing and subsequently install the dryer cartridge or activated carbon cartridge. The production of the expansion tank according to the invention can in particular even be automated, since the inner contour of the first receptacle, which is essentially complementary to an outer contour of the drying device, and the inner contour of the second receptacle, which is essentially complementary to an outer contour of the activated carbon cartridge, allow the drying device to be inserted into the first receptacle and the activated carbon cartridge to be positively inserted into the second receptacle, for which no worker is required. Due to the arrangement of both the first valve and the second valve on the tank housing, these two valves can also be replaced if the dryer device/activated carbon cartridge needs to be replaced and/or if the tank housing needs to be replaced, which can reliably prevent the valves from clogging due to excessive use, for example.

In an advantageous further development of the expansion tank according to the invention, the first valve is arranged in an intermediate wall which separates the second receptacle from an interior of the tank housing. Air is usually arranged in the interior of the tank housing, which is pressurized or depressurized depending on the temperature of the coolant by expansion or contraction of the coolant. By arranging the first valve in the partition wall that separates the second receptacle from the interior of the tank housing, the first valve can be directly assigned to the second receptacle. Downstream of the second receptacle, there is of course an opening in one wall of the tank housing to the outside for exchange with the environment.

The second valve is arranged in an outer wall of the tank housing, wherein the outer wall, in which the second valve is arranged, separates the first receptacle from the surroundings. Fresh air is thus drawn in from the environment when there is negative pressure in the tank housing or in the expansion tank via the second valve and the first receptacle in which the drying device is arranged. The fresh air drawn in from the environment is thus sucked in through the drying agent of the drying device and dried in the process, which in particular prevents moisture and/or water from entering the expansion tank. Excessive moisture could make the coolant electrically conductive, which can lead to a short circuit under unfavorable circumstances, particularly in the case of immersion cooling.

The second valve described can also be designed as a double valve, which also allows air to be blown out of the tank housing into the environment.

In a particularly preferred embodiment, a spring is arranged on the activated carbon cartridge, which pretensions the activated carbon cartridge against the tank housing. Such a spring can be used to achieve a reliable and fixed position of the activated carbon cartridge in the second receptacle, whereby the spring preload also prevents the activated carbon cartridge from generating rattling noises during operation, for example, which are perceived as disturbing. Such a spring can, for example, be designed as an inexpensive coil spring. The spring can also be used to pre-tension the activated carbon in the activated carbon cartridge, for example in the form of bulk material, but also, for example, in a bag, in particular made of polyester, provided that a lid can be displaced in a piston-type manner in a pot of the activated carbon cartridge, as a result of which it is subject to less wear during operation.

In a particularly preferred embodiment of the expansion tank according to the invention, the first shell and/or the second shell are/is designed as plastic injection-molded part(s). The design of the first and/or second shell as plastic injection-molded parts offers the great advantage of being able to manufacture the tank housing and thus also the expansion tank not only to a high quality, but also cost-effectively.

The first and second shells are conveniently welded together. When the two shells are designed as plastic injection-molded parts, it makes sense to weld them together to form a tight connection. Alternatively, the two shells can of course also be glued together. Alternatively, it is also theoretically conceivable that the two shells could be connected to each other via clip connections or screw connections, which offers the great advantage that the tank housing can be opened to replace the drying device or activated carbon cartridge and can continue to be used after the drying device or activated carbon cartridge has been replaced. In this case, a seal must be inserted between the two shells.

In a further advantageous embodiment of the expansion tank according to the invention, the first shell and/or the second shell are/is made of polyoxymethylene (POM). POM is a semicrystalline thermoplastic with high mechanical strength and rigidity and, in addition, high wear resistance and low moisture absorption, which is particularly advantageous when used for the expansion tank according to the invention, since in this case water retention or moisture absorption increases the electrical conductivity of a dielectric coolant. Alternatively, polyketone can also be used as the plastic for the first and/or second shell. Polyketones (PK) are high-performance thermoplastic polymers with high impact strength, low wear, good solvent resistance, and low water absorption. Polyketone also has a high level of environmental compatibility. In order to further increase the mechanical strength and also the wear resistance, the plastic can have glass fibers, in particular 25% glass fibers, and in particular be designed as POM GF-25.

The present invention is further based on the general idea of equipping a battery cooling system with an expansion tank described in the previous paragraphs and thereby transferring the advantages described with respect to the expansion tank to the battery cooling system. Specifically, the advantages of a battery cooling system equipped with the expansion tank according to the invention lie in its cost-effective manufacture, whereby only the expansion tank or, in the case of an openable tank housing, only the drying device and/or the activated carbon cartridge must be replaced if the drying device and/or the activated carbon cartridge need to be replaced.

Further important features and advantages of the invention are apparent from the subclaims, from the drawings, and from the associated description of the figures with reference to the drawings.

It is understood that the features mentioned above and those to be explained below can be used not only in the combination indicated in each case, but also in other combinations or on their own, without departing from the scope of the present invention. The above-mentioned components of a superordinate unit, such as a device, an apparatus, or an arrangement, which are designated separately, can form separate parts or components of this unit or be integral areas or sections of this unit, even if this is shown differently in the drawing.

Preferred embodiments of the invention are shown in the drawings and are explained in more detail in the following description, with identical reference signs referring to identical or similar or functionally identical components.

### BRIEF DESCRIPTION OF THE DRAWING

It shows, schematically in each case:

FIG. 1 shows a view of an expansion tank of a battery cooling system according to the invention,

FIG. 2 shows a representation as in FIG. 1, but from a different perspective,

FIG. 3 shows a sectional view of an expansion tank according to the invention with a drying device according to the invention and an activated carbon cartridge,

FIG. 4 shows a sectional view as in FIG. 3, but with a different drying device.

### DETAILED DESCRIPTION

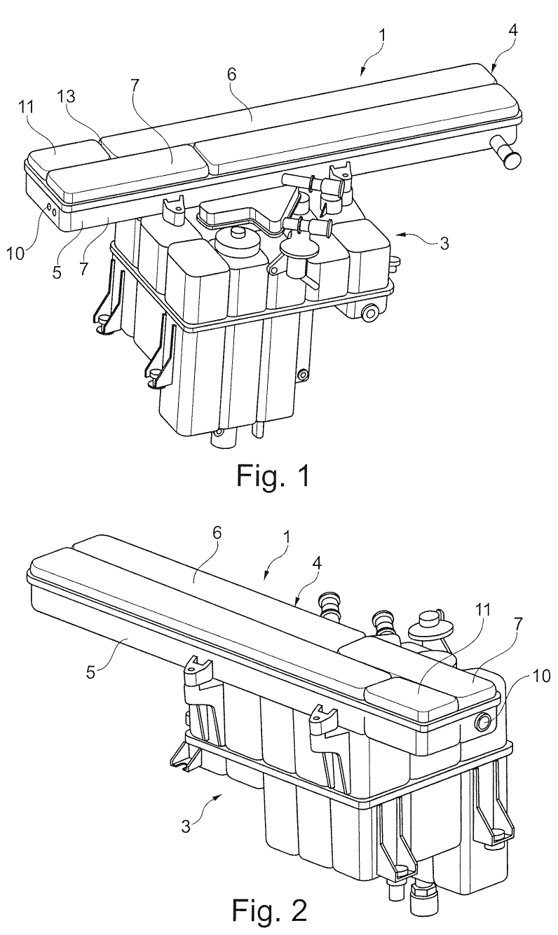

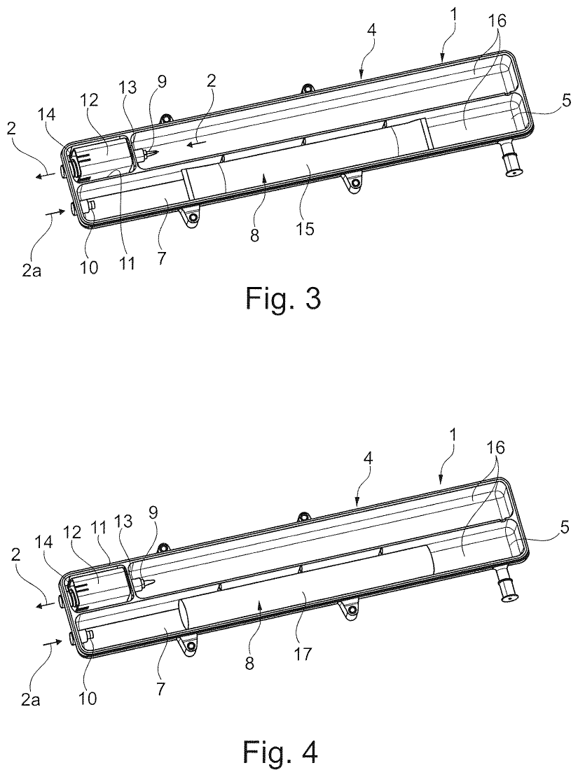

According to FIGS. 1 and 2, an expansion tank 1 for air 2 of a battery cooling system 3 according to the invention has a tank housing 4 made of plastic with a first shell 5 and a second shell 6 connected thereto. In the first tray 5 and/or in the second tray 6, a first receptacle 7 (see FIGS. 3 and 4) is/are provided or formed, in which a drying device 8 is arranged in a form-fitting manner.

The drying device 8 as shown in FIG. 3 has an air-permeable, bag-like housing 15 in which a drying agent is arranged. Alternatively, the drying device 8 can also have a dimensionally stable drying body 17 made of a sintered, extruded, or sprayed drying agent, as shown in FIG. 4.

Looking at FIG. 3, a drying device 8 can be seen in which the bag-like housing 15 is made of polyester fabric. Of course, other materials that are resistant to the coolant in the battery cooling system 3 are also conceivable. The drying agent can be arranged as bulk material in the bag-like housing 15, for example as beaded silica gel or zeolite. As a result, the outer contour of the drying device 8 can be optimally adapted to the inner contour of the first receptacle 7, enabling a positive and reliable fit. In particular, the form-fit mounting can also prevent an undesired bypass flow of the fresh air 2a drawn in.

The drying agent used for the dimensionally stable drying device 8 as shown in FIG. 4 can also contain silica gel or zeolite. As shown in FIG. 4, the dimensionally stable drying body 17 made of pressed, sintered, extruded, or sprayed drying agent has a rod-like shape.

In this case, the drying device 8 or the drying body 17 can have a shape that is complementary to an inner contour of the first receptacle 7 in the tank housing 4 of the expansion tank 1, whereby a form-fitting insertion of the drying device 8 into the associated first receptacle 7 of the tank housing 4 can be achieved without the dimensionally stable drying body 17 made of extruded, sintered, or sprayed drying agent requiring an additional housing, which can reduce the manufacturing costs.

Furthermore, the expansion tank 1 according to the invention has a first valve 9, via which air 2 can be blown out of the expansion tank 1 into the environment when there is excess pressure in the expansion tank 1. Fresh air 2a from the environment enters the expansion tank 1 via a second valve 10 when there is a vacuum in the expansion tank 1.

In addition, a second receptacle 11 is formed in the first shell 5 and/or the second shell 6, in which an activated carbon cartridge 12 (see also FIGS. 3 and 4) is positively received. The expansion tank 1 shown thus has the tank housing 4 with the two receptacles 7, 11 arranged therein, in which the drying device 8 and the activated carbon cartridge 12 are arranged. If there is excess pressure in the expansion tank 1, air 2 flows through the first valve 9 and the activated carbon cartridge 12 arranged in the second receptacle 11 to the outside. By blowing air 2 through the activated carbon cartridge 12, pollutants in particular, such as hydrocarbons, can be reliably retained. Fresh air 2a from the environment is drawn into the expansion tank 1 via the second valve 10 and the drying device 8, in which the fresh air 2a drawn in is dried.

The first valve 9 is arranged in an intermediate wall 13, which separates the second receptacle 11 from the interior 16 of the tank housing 4. The second valve 10, which can also be designed as a double valve, i.e., a valve that is permeable in both directions, is arranged in an outer wall of the tank housing 4, which separates the first receptacle 7 from the surroundings. Of course, the second valve 10 described above and a further pressure relief valve, via which air 2 is blown out of the expansion tank 1 into the environment, can also be arranged in the outer wall of the tank housing 4.

Looking further at FIGS. 3 and 4, it can be seen that a spring 14 is arranged on the activated carbon cartridge 12, which pretensions the activated carbon cartridge 12 against the tank housing 4, in this case specifically against the intermediate wall 13. The spring 14 can be used to achieve vibration-free, and therefore rattle-free, fixing of the activated carbon cartridge 12 in the second receptacle 11. In particular, this results in increased user comfort due to lower noise levels.

The first shell 5 and/or the second shell 6 can be designed as plastic injection-molded part(s), which enables not only high-quality but also cost-effective production. The two shells 5, 6 can be welded or glued together, although it is also theoretically conceivable that the two shells 5, 6 are connected to each other via clip connections or screw connections, which offers the great advantage that the tank housing 4 can be opened to replace the drying device 8 or the activated charcoal cartridge 12 and can continue to be used after the drying device 8 or the activated charcoal cartridge 12 has been replaced.

The first shell 5 and/or the second shell 6 can be made of polyoxymethylene (POM) or polyketone, i.e., of a plastic with high strength and low moisture absorption, which is particularly advantageous for an expansion tank 1 for air 2 of a battery cooling system 3. In order to further increase the strength and wear resistance of the tank housing 4, the plastic of the two shells 5, 6 can be reinforced with fibers, in particular glass fibers.

All in all, the drying device 8 according to the invention, the expansion tank 1 according to the invention, and the battery cooling system 3 according to the invention can be used to create an extremely cost-effective and space-optimized solution.

1. A drying device of an expansion tank for a battery cooling system, the drying device comprising:
an air-permeable, bag-like housing including a drying agent; or
a dimensionally stable drying body made of the drying agent that is sintered, extruded, or sprayed.

2. The drying device according to claim 1, wherein the bag-like housing is made of polyester fabric.

3. The drying device according to claim 1, wherein the drying agent is arranged as bulk material in the bag-like housing.

4. The drying device according to claim 1, wherein the dimensionally stable drying body has a bar-like shape.

5. The drying device according to claim 1, wherein the drying agent includes at least one of silica gel or zeolite.

6. An expansion tank for a battery cooling system, the expansion tank comprising:
a tank housing made of plastic, with a first shell and a second shell connected thereto;
a first receptacle in the first shell or in the second shell;
a drying device in the first receptacle, the drying device comprising:
an air-permeable, bag-like housing including a drying agent, or
a dimensionally stable drying body made of the drying agent that is sintered, extruded, or sprayed;
a first valve, via which air is released from the expansion tank into the environment when there is excess pressure in the expansion tank; and
a second valve, via which fresh air from the environment enters the expansion tank when there is a vacuum in the expansion tank.

7. The expansion tank according to claim 6, further comprising:
a second receptacle in the first shell or in the second shell; and
an activated carbon cartridge in the second receptacle.

8. The expansion tank according to claim 7, wherein the first valve is arranged in an intermediate wall which separates the second receptacle from an interior of the tank housing.

9. The expansion tank according to claim 6, wherein at least one of the first shell or the second shell is a plastic injection-molded part.

10. The expansion tank according to claim 6, wherein the first shell and the second shell are connected by at least one of welding, clipping, screwing, or gluing.

11. The expansion tank according to claim 6, wherein at least one of the first shell or the second shell is made of polyoxymethylene (POM) or polyketone.

12. The expansion tank according to claim 6, wherein at least one of the first shell or the second shell is made of plastic including glass fibers.

13. The expansion tank according to claim 6, wherein the second valve is arranged in an outer wall of the tank housing, which separates the first receptacle from the environment.

14. A battery cooling system, comprising:
an expansion tank comprising:
a tank housing made of plastic, with a first shell and a second shell connected thereto;
a first receptacle in the first shell or in the second shell;
a drying device in the first receptacle, the drying device comprising:
an air-permeable, bag-like housing including a drying agent, or
a dimensionally stable drying body made of the drying agent that is sintered, extruded, or sprayed;
a first valve, via which air is released from the expansion tank into the environment when there is excess pressure in the expansion tank; and
a second valve, via which fresh air from the environment enters the expansion tank when there is a vacuum in the expansion tank.

15. The battery cooling system according to claim 14, wherein the expansion tank further comprises:
a second receptacle in the first shell or in the second shell; and
an activated carbon cartridge in the second receptacle.

16. The battery cooling system according to claim 15, wherein the first valve is arranged in an intermediate wall which separates the second receptacle from an interior of the tank housing.

17. The battery cooling system according to claim 14, wherein at least one of the first shell or the second shell is a plastic injection-molded part.

18. The battery cooling system according to claim 14, wherein the first shell and the second shell are connected by at least one of welding, clipping, screwing, or gluing.

19. The battery cooling system according to claim 14, wherein at least one of the first shell or the second shell is made of polyoxymethylene (POM) or polyketone.

20. The battery cooling system according to claim 14, wherein the second valve is arranged in an outer wall of the tank housing, which separates the first receptacle from the environment.
